(19) United States
(12) Patent Application Publication
(10) Pub. No.: US 2005/0102178 A1
(43) Pub. Date: May 12, 2005

(54) Systems and methods for generating multiple revenue streams involving the use of an integrated appliance

(76) Inventors: Daniel William Phillips, Cumming, GA (US); Mark Louis Goodman, Alpharetta, GA (US); David Warren Hostetter, Acworth, GA (US); Donny McDonald, Alloa (GB)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/703,967

(22) Filed: Nov. 7, 2003

(51) Int. Cl. G06F 17/60

(52) U.S. Cl. 705/14; 705/52

(57) ABSTRACT

Systems for generating multiple revenue streams are provided. One such system includes an integrated appliance that incorporates a display. The integrated appliance is operative to display content to a user via the display and provide the user with passthrough communication connectivity so that the user can interconnect a computing device to the integrated appliance and be provided with at least one of passthrough telephone network access and passthrough Internet access. Methods also are provided.

### DESCRIPTION OF THE RELATED ART

Presently, there are approximately five million hotel rooms in the United States. However, many of these rooms lack services that are typically desired by guests, such as high-speed Internet access and economical telephone access, as well as entertainment services, such as movies and games. Even when such services are able to be provided, a facility may not offer these services because the profit margin on such services can be quite low.

From the perspective of a traveler, the lack of such services may make it difficult for the traveler to access information when they are away from their homes or offices. Therefore, if a facility fails to provide such a traveler with convenient access to information, the traveler may not desire to stay at a similar facility at a later date. Also, to the inconvenience of the traveler, that traveler may be forced to travel with an oftentimes expensive and heavy computing device, such as a laptop computer.

### SUMMARY

Systems and methods for generating multiple revenue streams are provided. In this regard, an embodiment of a system for generating multiple revenue streams includes an integrated appliance that incorporates a display. The integrated appliance is operative to display content to a user via the display and provide the user with passthrough communication connectivity so that the user can interconnect a computing device to the integrated appliance and be provided with at least one of passthrough telephone network access and passthrough Internet access.

An embodiment of a method comprises the steps of: providing an integrated appliance for use in a room of a lodging facility, the integrated appliance being operative to provide Internet access and telephone service to the room; generating a first revenue stream corresponding to the providing of the integrated appliance; acquiring information corresponding to a guest of the lodging facility; displaying content, in-room, to the guest of the lodging facility using the integrated appliance, the content being based, at least in part, on the information corresponding to the guest; and generating a second revenue stream corresponding to displaying the content using the integrated appliance.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram of an embodiment of a system for generating multiple revenue streams.

FIG. 2 is schematic diagram of an embodiment of a system that can be used to provide information to users with integrated appliances.

FIG. 3 is a schematic diagram of an embodiment of a facility incorporating multiple integrated appliances.

FIG. 4 is a schematic diagram of a computer or processor-based device that can be used to implement various functionality associated with a system that incorporates that use of an integrated appliance.

FIG. 5 is a flowchart depicting functionality of an embodiment of a host server.

FIG. 6 is a flowchart depicting functionality of an embodiment of an on-site server.

FIG. 7 is a flowchart depicting functionality of an embodiment of an integrated appliance.

FIG. 8 is schematic diagram of another embodiment of a system that can be used to provide information to users viah integrated appliances.

FIG. 9 is schematic diagram of yet another embodiment of a system that can be used to provide information to users via integrated appliances.

FIG. 10 is a front perspective view of another embodiment of an integrated appliance.

FIG. 11 is a rear perspective view of the embodiment of the integrated appliance of FIG. 10.

FIG. 12 is a partially-exploded, perspective view of the embodiment of the integrated appliance of FIGS. 10 and 11.

FIG. 13 is a schematic diagram depicting exemplary connectivity between a representative computing device, a representative television and a representative security device interfacing with an embodiment of an integrated appliance.

FIG. 14 is a schematic diagram depicting another embodiment of an integrated appliance.

FIGS. 15-19 are representative screen shots provided by an embodiment of information system and displayed to a user with an embodiment of an integrated appliance.

### DETAILED DESCRIPTION

As will be described in detail here, systems and methods are provided for generating multiple revenue streams. In particular, the systems and methods involve the use of integrated appliances, several embodiments of which will be described in detail later.

As used herein, the term “integrated appliance” refers to a device that is able to provide Internet access and telephone service to a user and that incorporates the use of a display. As will be described in detail with respect to the accompanying drawings, an integrated appliance has the potential of being a revenue-generating telecommunication product that is particularly well suited to the worldwide hospitality industry. By way of example, an integrated appliance can be used as an in-room appliance for providing concierge services, travel-related products and Internet access. By working in concert with hoteliers, for example, Internet service providers, telephone service providers, providers of goods and/or services, use of an integrated appliance can transform the typically lack-luster experience of a guest of a hotel or other facility into a high-quality and exciting experience.

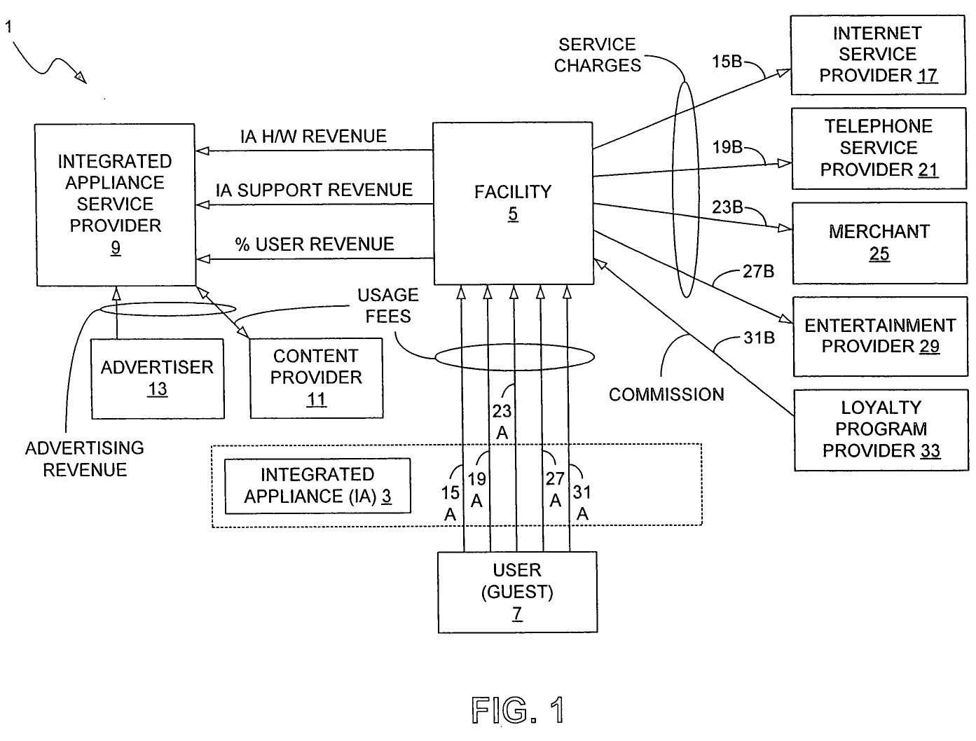

Referring now to the drawings, FIG. 1 is a schematic diagram depicting representative revenue streams that can be generated by an embodiment of a system that involves the use of an integrated appliance. As shown in FIG. 1, the system 1 uses an integrated appliance 3 that is located at a facility 5. By way of example, the facility can be a lodging facility, such as a hotel or other facility at which a user may desire access to information, e.g., information provided by the Internet. In the exemplary embodiment of FIG. 1, integrated appliance 3 provides user 7 with information.

In order that the integrated appliance 3 is able to provide the user 7 with the desired information, an integrated appliance service provider 9 accommodates this need. Specifically, integrated appliance service provider 9 typically is responsible for the integrated appliance 3 with respect to ensuring that the hardware and/or software associated with the integrated appliance functions properly. For providing these services, facility 5 typically provides the integrated appliance service provider 9 with revenue, such as in the form of hardware revenue, e.g., an equipment lease, and support revenue, e.g., a software support agreement.

Clearly, various arrangements can be secured for providing integrated appliance 3 to facility 5. For instance, a facility may purchase integrated appliances outright, or may lease the appliances. The costs associated with an integrated appliance may be provided above, at or below the cost to the integrated appliance service provider, depending upon the relationship with the facility. As will be described in detail later, the integrated appliance service provider also is able to generate revenue associated with various services provided to a user via the integrated appliance.

In supporting use of integrated appliance 3, integrated appliance service provider 9 is able to provide various content for display via the integrated appliance. By way of example, news and/or other types of information can be provided by content provider 11. Depending upon the particular business relationship established between service provider 9 and content provider 11, the service provider may be able to generate advertising revenue from the content provider 11 and/or may be required to pay a usage fee to the content provider for displaying the associated content. Service provider 9 also may be able to generate advertising revenue from an advertiser 13 that would be payable to service provider 9 for displaying advertisements via the integrated appliance.

As mentioned before, when the user 7 accesses various types of information via integrated appliance 3, various usage fees can be generated that are typically payable to facility 5. By way of example, when user 7 accesses the Internet using integrated appliance 3, the user may be charged a usage fee 15A by the facility. In turn, facility 5 may pay a service charge 15B to an Internet service provider 17 that provides the Internet access to the user. Note that the integrated appliance service provider also can serve as an Internet service provider in some embodiments.

User 7 also can use integrated appliance 3 to place and receive telephone calls. Particularly, with respect to placing a call, a usage fee 19A typically is payable to facility 5. Also associated with use of a telephone can be service charges 19B payable to telephone service provider 21 by the facility. Note that any of the usage fees shown flowing from user 7 to facility 5, and then to a service provider can be in addition to, or in lieu of, other payments that flow directly from the user to a service provider.

User 7 also can use the integrated appliance 3 to purchase various goods and/or services that may be offered for sale by a merchant 25. Typically, such a purchase results in usage fees 23A payable to the facility. Correspondingly, a payment 23B typically is due from facility 5 to the merchant, in those embodiments where the facility actually facilitates the transaction, for example.

A integrated appliance 3 can provide user 7 with entertainment, such as in the form of games and/or movies, as will be described in detail later. This activity can generate a usage fee 27A. A service charge 27B also may be due to the entertainment provider 29 by facility 5.

Integrated appliance 3 also can provide links to loyalty programs that can encourage brand recognition. For instance, integrated appliance 3 can provide a means by which a user 7 can use and/or acquire loyalty program incentives. By way of example, an integrated appliance and associated systems can track loyalty incentives of a guest in real-time. The integrated appliance can be used to trade loyalty incentives for goods and/or services of partners associated with a particular loyalty program.

In providing information to a user, an integrated appliance can deliver site-specific dynamic content. By way of example, the content can be driven based on the user name and geographic and/or demographic information corresponding to the user that is acquired by a facility. For instance, when the facility is a lodging facility, an integrated appliance can display information that is dynamically provided based on the name and zip code of the user that is typically obtained during check-in. Thus, upon arriving at a room, the user can be provided with a personalized welcome and information corresponding to the user's home town, both of which are displayed via the integrated appliance located in the room.

Other guest-centric information provided by an integrated appliance can include hotel information (spa, restaurant menus, convention times), area information (local restaurants, night clubs, and hot spots), travel related goods and/or services (flowers, luggage, reservations and transportation), entertainment (games and movies), email access, and high speed Internet access, for example. As a benefit to the facility, providing these services can equate to a more pleasant stay to the user and can generate additional revenue opportunities such as those described before with respect to FIG. 1.

Information corresponding to the user also can be used in conjunction with the loyalty program incentives. For instance, hotel occupancy rates for hotels at another location can be reviewed and if it is determined that the rates are low, information corresponding to a discount at one of those hotels can be displayed to the user via the Internet appliance in that guest's room.

One advantage potentially offered by use of integrated appliances is that various statistical information can be gathered corresponding to users of a facility. By way of example, time spent viewing, number of hits per advertisement and general usage history information can be acquired for each user. This information can be used by the facility for evaluating effectiveness of the integrated appliance. Additionally or alternatively, advertisers and merchants can evaluate the effectiveness of their advertising by reviewing the information acquired. Acquired information also can be used by the integrated appliance service provider for recalibrating content provided to particular guests.

The aforementioned ability to provide reports to advertisers turns their typically intangible purchase of advertising into a tangible report of usage. From a facility viewpoint, these facilities typically have placed printed advertising materials at rooms targeted to their guests and receive no share of revenue if the users actually buy products and/or services based on the printed advertising. By using an integrated appliance, ad revenue and potentially a portion of revenue generated by sales of goods and/or services by those placing these ads can be shared with the facility.

As should be understood, an integrated appliance can offer a guest dynamic news, weather, sports and financial information, for example, along with services and amenities designed to meet the interests of the guest. All of this information and options can be provided to the user in a private, in-room setting, where the guest is able to relax and take time to enjoy the information provided. Such an integrated appliance also provides a facility with an in-room device that is able to provide the guest with the branding of the facility while offering the potential of increased revenues. With respect to the advertiser that uses the integrated appliance, the advertiser can obtain access to targeted demographics and statistics that reveal results of their advertising efforts.

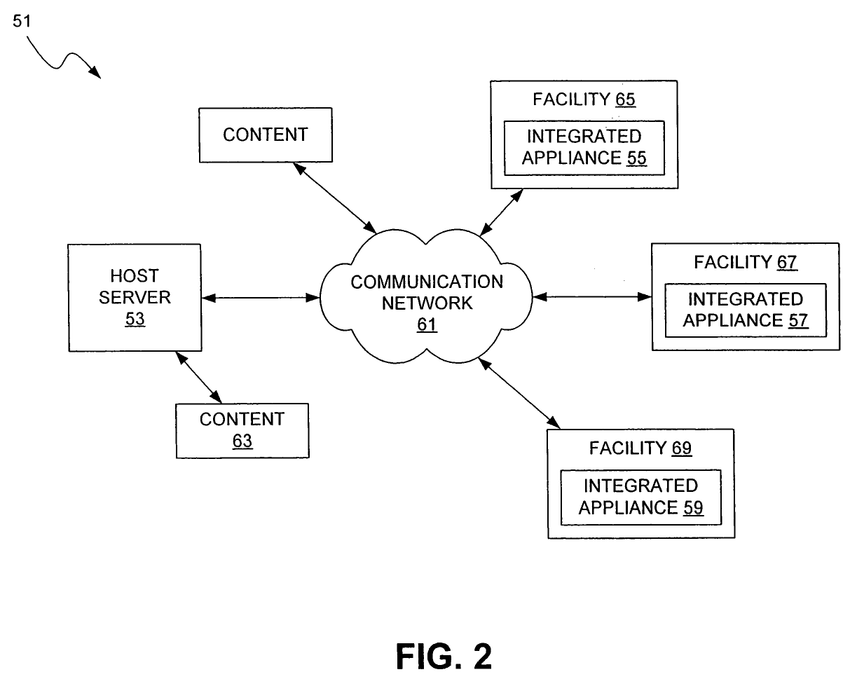

Reference will now be made to FIG. 2, which depicts an embodiment of a system 51 that incorporates multiple integrated appliances, e.g., appliances 55, 57 and 59, that communicate with a host server 53. Communication between the host server 53 and the various integrated appliances is facilitated by communication network 61. Note, communication network 61 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

Host server 53, which can comprise one or more server devices, typically is responsible for controlling content distribution, data security, maintenance, and monitoring and reporting of the various integrated appliances that communicate with the host server. By way of example, the host server 53 can facilitate the transfer of content, such as content 63, to an integrated appliance via communication network 61. By way of further example, host server 53 can monitor physical security of an integrated appliance by notifying a facility when a theft condition of the appliance is identified. For instance, if communication with an integrated appliance is disrupted, a notification in the form of an automated message can be sent from the host server and/or on-site server to inform personnel of the condition, such as via email, pager or mobile phone.

The host server can be used to monitor the status of individual integrated appliances and ensure that they are active. Remote diagnostic and servicing capabilities also can be facilitated. Other functions that may be included in embodiments of the host server can include self re-booting, the ability to upgrade and/or change software remotely, and maintaining information corresponding to events and usage. With respect to maintaining information, in-depth details of the performance and usage of the integrated appliances can be acquired real-time. Information acquired can be used to provide various reports, such as usage, billing and system functionality reports to a lodging facility, the integrated appliance service provider and advertisers, for example.

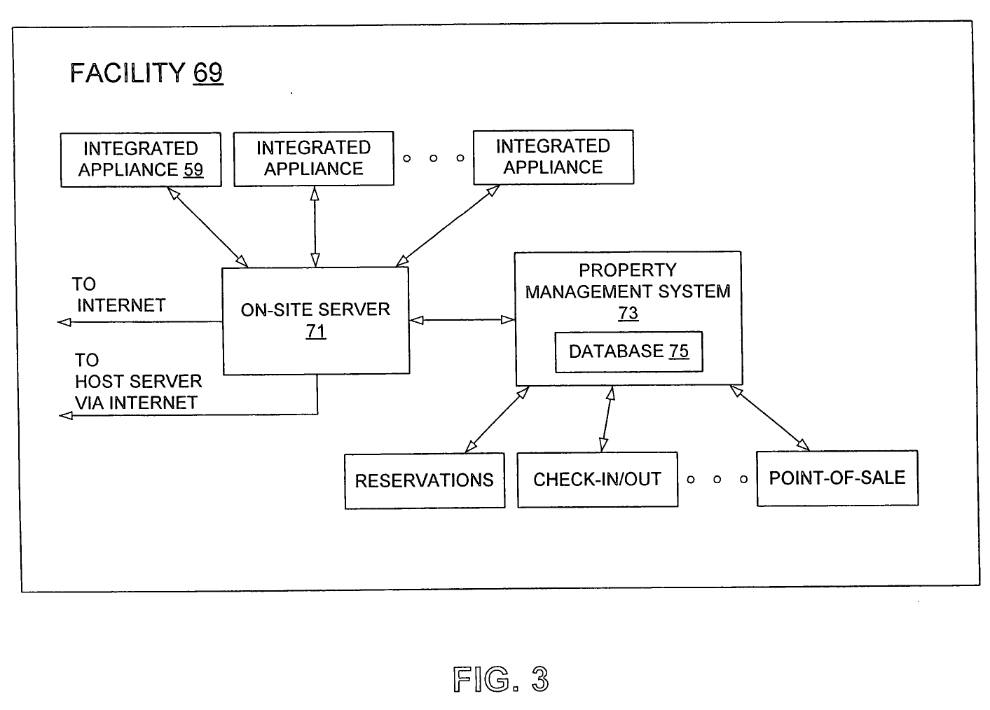

Although multiple facilities, e.g., facilities 65, 67 and 69, and associated integrated appliances are depicted in FIG. 2, reference will now be made to FIG. 3 and facility 69 for the purpose of describing the use of an embodiment of an integrated appliance in providing information to a user. As shown in FIG. 3, facility 69, which may be a lodging facility such as a hotel, includes multiple integrated appliances. Typically, each integrated appliance, e.g., appliance 59, is located in a separate room or other location, such as a lobby, so that a user can be provided with convenient access to information. Each integrated appliance communicates with on-site server 71 that provides various functionality to the integrated appliances.

By way of example, the on-site server 71 functions as a web server and provides content to the integrated appliances, such as local content that may be selected by the facility. The on-site server 71 also receives content provided by the host server 53 (FIG. 2) and directs that content to the appropriate integrated appliance. In some embodiments, the on-site server and integrated appliance use a protocol/booting technique, such as Preboot Execution Environment (PXE). Use of PXE enables the on-site server to store a memory image associated with each integrated appliance. Thus, if one of the integrated appliances needs to be rebooted, its corresponding image is uploaded from the on-site client. Use of such a protocol enables integrated appliances to receive updates of information and/or programming by modifying the stored image and then uploading the modified image on the next reboot.

The on-site server 71 can integrate with the facility telephone system and the facility Property Management System (PMS) 73. In interacting with the PMS system 73, such a PMS system can be used to facilitate reservations, check-in/check-out, and potentially various point-of-sale activities, for example, that are undertaken at a facility. To facilitate this functionality, the PMS system 73 typically manages a database 75 for storing information associated with a user, in this case, a guest of the facility. The on-site server 71, depending upon a relationship established with the facility, can access at least some of the information of the PMS database 75. By way of example, such information can include user name, address, length of stay, type of room (suite or budget room), and registration for events. The on-site server 71 can parse this information and optionally communicate at least some of the information to the host server so that dynamic content can be provided to an integrated appliance corresponding to that user. Thus, the on-site server 71 can direct content associated with a user's hometown to the user via an integrated appliance located in that user's room.

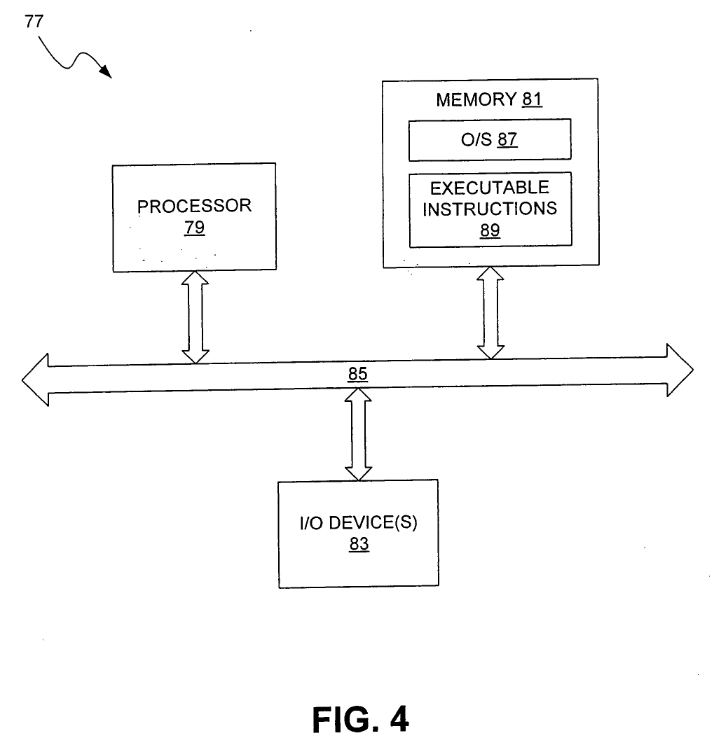

Functionality associated with a system, such as depicted in FIGS. 2 and 3, can be implemented in software, firmware, hardware, or a combination thereof. When implemented in software, the functionality is implemented as executable programs that can be executed by a special or general-purpose digital processor(s). An example of such a system is shown schematically in FIG. 4.

Generally, in terms of hardware architecture, computer 77 includes a processor 79, memory 81, and one or more input and/or output (I/O) devices 83 that are communicatively coupled via a local interface(s) 85. The memory 81 can include one or more separate programs, each of which comprises an ordered listing of executable instructions for implementing logical functions. In the example of FIG. 4, the memory 81 includes an operating system (O/S) 87 and executable instructions 89.

Executable instructions 89 can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Executable instructions 89 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Reference is now made to several flowcharts, each of which depicts the functionality of an embodiment of an associated system and/or method. It should be noted that, in some alternative implementations, the functions noted in the various blocks of the flowcharts may occur out of the order depicted.

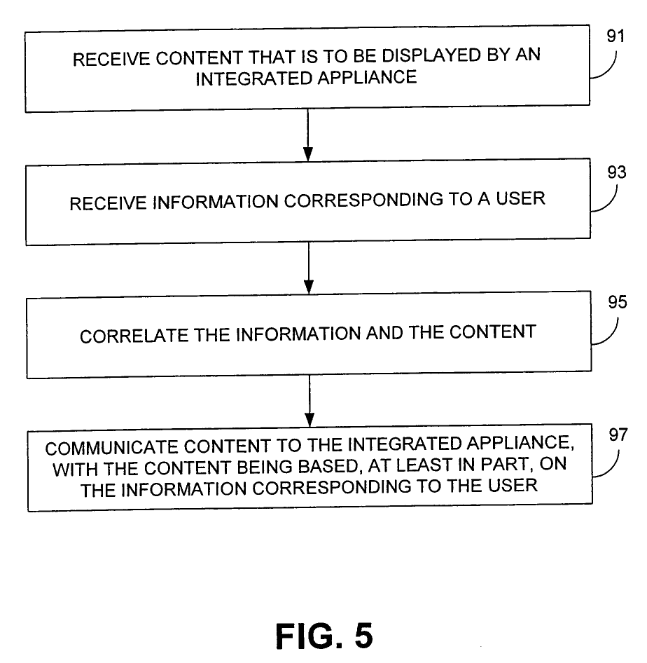

Functionality of an embodiment of a host server is depicted by flowchart of FIG. 5. As shown in FIG. 5, the functionality (or method) may be construed as beginning at block 91, where content that is to be displayed by an integrated appliance is received. In block 93, information corresponding to a user is received. By way of example, the information can be demographic information associated with a guest of a lodging facility to which the host server provides information. In block 95, the information corresponding to the user is correlated with the content. Then, as depicted in block 97, content is communicated to an integrated appliance associated with the user, with the content being based, at least in part, upon the information corresponding to the user.

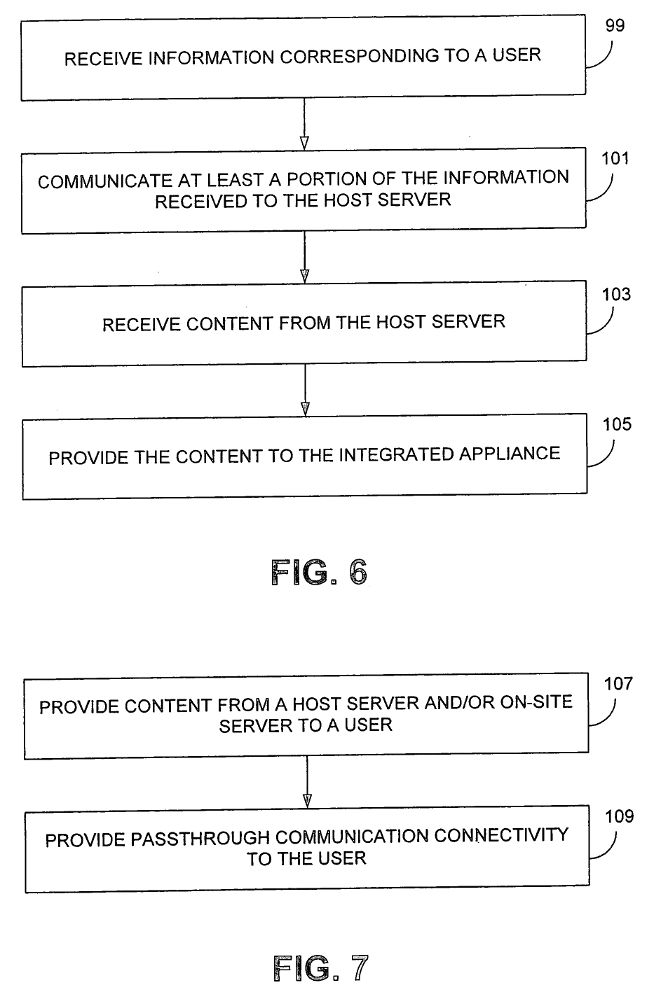

FIG. 6 is a flowchart depicting functionality of an embodiment of an on-site server. As shown in FIG. 6, the functionality (or method) may be construed as beginning at block 99, where information corresponding to a user is received. By way of example, the information can be provided by a property management system associated with the facility at which the on-site server is located. In block 101, at least a portion of the information received is communicated to a host server, which can then process the information, such as in the manner described above with respect to FIG. 5. In block 103, content is received from the host server and, in block 105, the content received is provided to an integrated appliance associated with the user. Typically, the integrated appliance displays the content.

Embodiments of an on-site server typically include management software that organizes and distributes dynamic content to associated integrated appliances. Typically, the on-site server also provides a web interface for hotel administrative functions and interfaces with selected hotel systems such as PMS, point-of-sale and facility telephone service. The on-site server also typically monitors the integrated appliances continuously and is able to detect faults and provides various alarm functionality. In some embodiments, an on-site server can include maintenance software to correct faults experienced by an integrated appliance and can also initiate a reset. Some embodiments of an on-site manager also can facilitate secure remote access to an integrated appliance from an associated host server.

Functionality associated with an embodiment of an integrated appliance is depicted in the flowchart of FIG. 7. As shown in FIG. 7, the functionality (or method) may be construed as beginning at block 107, where content provided by a host server and/or on-site server is provided to a user. In block 109, passthrough communication connectivity also is provided to the user. By way of example, such an integrated appliance can provide passthrough telephone functionality and/or passthrough Internet access functionality as will be described in detail later.

In some system embodiments, virtual local area networks (VLANs) are used to segregate computer devices that a user may bring to a facility, such as a laptop, from the integrated appliances provided by such a facility. In some embodiments, multiple VLANs also can be used to segregate access to the on-site server and an high-speed Internet access server. In such embodiments, the integrated appliances should only be able to communicate with the on-site server, and the computing devices provided by a user (guest) can only communicate with the high-speed Internet access server. In such an embodiment, the on-site server is configured to respond to configuration requests from the integrated appliances only, via VLAN. Integrated appliance media access control (MAC) addresses and switch port numbers can be used to track, identify and validate integrated appliance room locations by the on-site server. Similarly, the high-speed Internet access server is configured to respond to requests only from attached computer devices operated by the guests. Typically, the high-speed Internet access server and on-site server can utilize the same router/firewall components for providing high-speed Internet access.

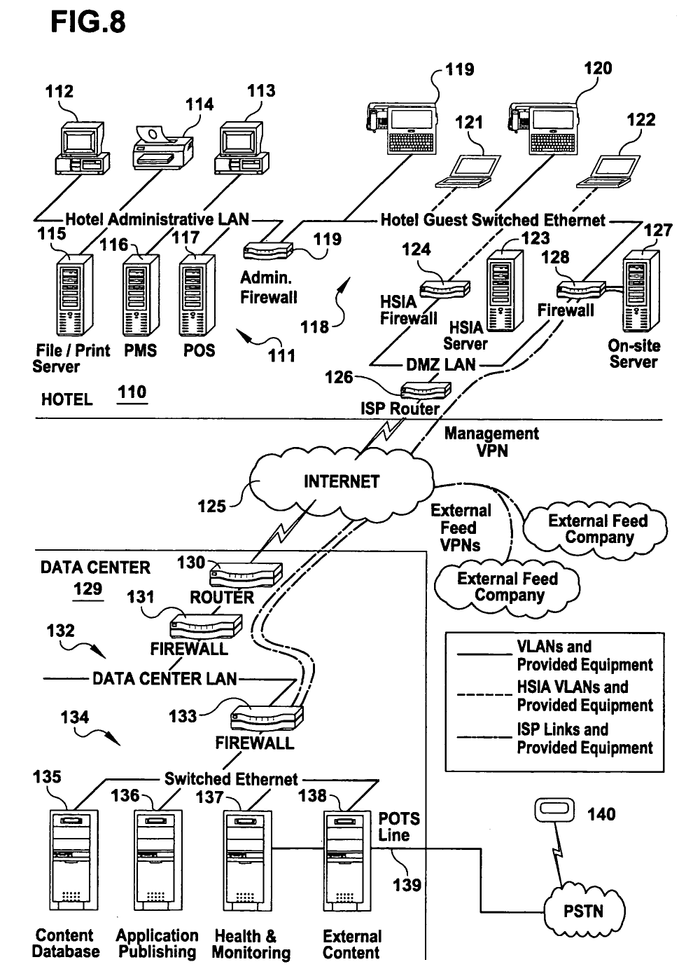

Typically, an on-site server requires the use of two public IP addresses. i.e., one for integrated appliance Internet access IP mapping, and the other for secure server access by the host server. In such an embodiment, the on-site server also typically requires one private IP address for interfacing with facility systems. An embodiment of a system that can be used to implement at least some of the aforementioned functionality will now be described with respect to the schematic diagram of FIG. 8.

As shown in FIG. 8, system 110 includes a facility, in this case a hotel that includes multiple devices within a hotel administrative LAN 111. These devices include workstations 112 and 113, printer 114, a file/print server 115, a PMS server 116 and a point-of-sale (POS) server 117. The hotel administrative LAN 111 communicates with a hotel guest switched Ethernet 118 via a firewall 119. Exemplary devices connected to the hotel guest switched Ethernet 118 include integrated appliances 119 and 120 and guest computing devices 121 and 122.

As depicted in FIG. 8, guest computing devices 121 and 122 can access the high-speed Internet access server 123 via a high-speed Internet access firewall 124. This enables either of the devices 121, 122 to communicate with the Internet 125, such as via interaction with ISP router 126. In contrast, integrated appliances 119, 120 can communicate with on-site server 127 via a firewall 128.

Communication between on-site server 127 and data center 129 can be facilitated via ISP router 126, router 130 and firewall 132. Additionally or alternatively, communication can be established via virtual private network (VPN) connectivity to data center 129. Regardless of the routing used, information typically is routed through a firewall 133 interposed between the data center LAN 132 and a switched Ethernet LAN 134 of the data center 129.

In this embodiment, host server functionality is facilitated by multiple devices that communicate via switched Ethernet LAN 134, including a content database server 135, an application/publishing server 136, a health and monitoring server 137, and an external content server 138. In this embodiment, the health and monitoring server 137 and external content monitor 138 are connected to local telephone network 139, which enables automatic messages to be sent to remote devices such as a pager 140.

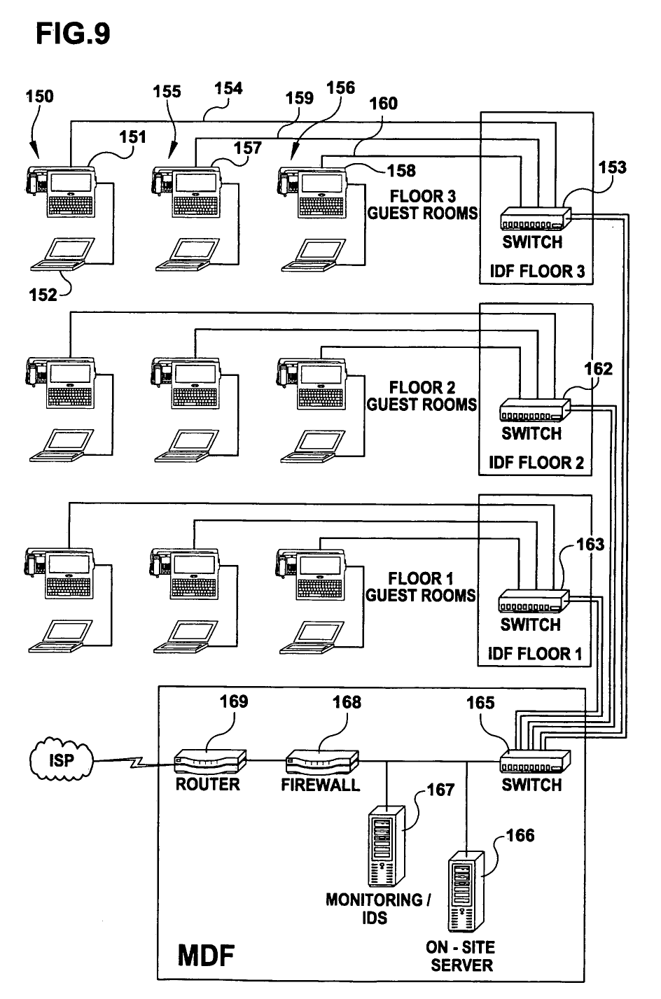

Another embodiment of a system that utilizes integrated appliances is depicted schematically in FIG. 9. In particular, this diagram depicts generally those components that are located at a facility and permit communication of those components with a communication network.

As shown in FIG. 9, the system includes multiple integrated appliances, each of which is shown with a user computing device connected thereto. By way of example, room 150 has an integrated appliance 151 located therein, to which is connected a computing device 152. Note that each of the computing devices depicted in FIG. 9 communicates with its associated integrated appliance by one of the pass-through portals provided by the integrated appliance. As such, a single communication link is depicted connecting each integrated appliance to the LAN. Returning to room 150, integrated appliance 151 communicates with a LAN switch 153, which may be located in an intermediate distribution frame (IDF) of the facility, via a communication link 154.

Other rooms, such as rooms 155 and 156, also include integrated appliances that communicate with switch 153. Specifically, integrated appliance 157 of room 155 and integrated appliance 158 of room 156 communicate with switch 153 via communication links 159 and 160, respectively.

In FIG. 9, rooms 150, 155 and 156 are located are floor 3 of the facility, with all integrated appliances of that floor utilizing switch 153. Similarly, integrated appliances of other floors use other LAN switches. By way of example, integrated appliances of floor 2 utilize switch 162 and integrated appliances of floor 1 utilize switch 163. Communications from switches 153, 162 and 163 are provided to a switch 165, which is used to provide information to the on-site server and/or facilitate communication outside of the facility. In this embodiment, the on-site server 166 is located in the main distribution frame (MDF) of the facility. Note that, in this embodiment, a separate monitoring and intrusion detection system 167 is employed. In other embodiments, such as described previously, the on-site server can perform the monitoring and intrusion detection services provided by device 167. Outgoing communications are then routed through firewall 168 and router 169 to their intended destinations, and vice versa.

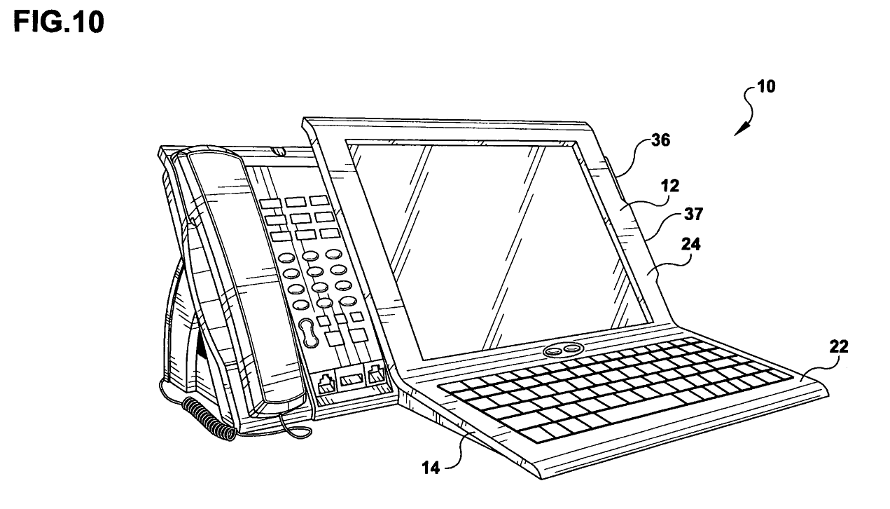

Several embodiments of an integrated appliance will now be described with reference to FIGS. 10-14. U.S. patent application Ser. No. ______, entitled “Systems for Providing Information to User via Communication Networks,” which was filed concurrently herewith, also discloses systems that involve the use of integrated appliances. That application is incorporated by reference herein.

FIGS. 10-12 depict an embodiment of an integrated appliance 10 that includes a housing 12 formed of various bezels and covers. Specifically, housing 12 includes a base cover 14, a rear screen cover 16, a rear buttress cover 18, a telephone bezel 20, a keyboard bezel 22 and a screen bezel 24.

Various components are mounted within the housing 12. In particular, keyboard module 30 is seated upon base cover 14, with keyboard bezel 22 securing the keyboard module 30 in position on base cover 14. Keyboard module 30 is located adjacent to and in front of a display assembly that includes an LCD panel 32, a touchscreen plate 34 and a touchscreen 35. By way of example, the display assembly can include a 12.1 touchscreen color LCD with 1024×768 pixel resolution.

The display assembly is supported by the rear screen cover 18, which orients the display assembly in an inclined relationship with respect to the keyboard module 30. Screen bezel 24 surrounds a perimeter of the display assembly.

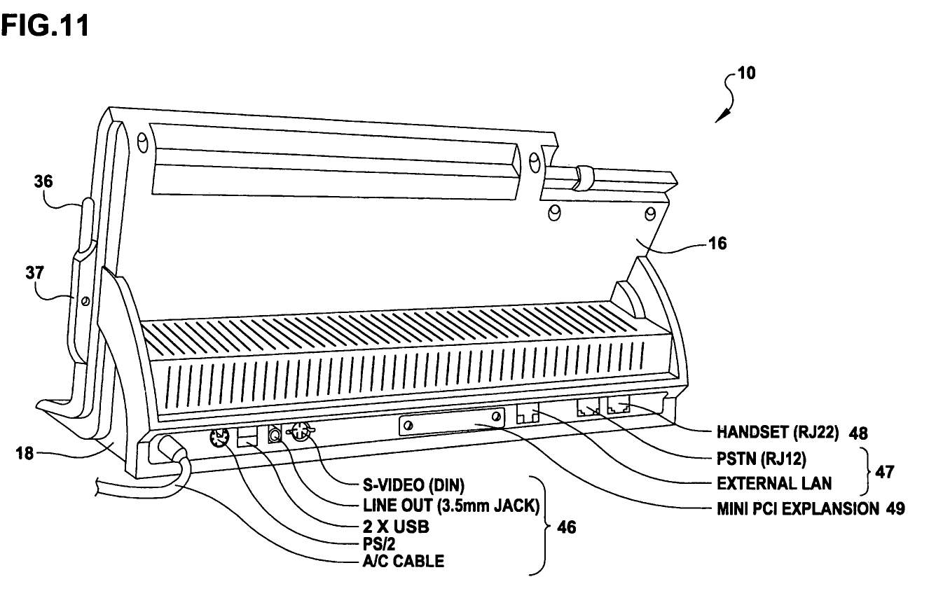

Although preferably operable by a user with the touch of a finger, the embodiment depicted in FIGS. 10-12 includes a stylus 36. As shown best in FIG. 11, stylus 36 can be mounted within a stylus sleeve 37 that is attached to the telephone bezel 24. Thus, when a user desires to use the stylus, stylus 36 can be removed from stylus sleeve 37.

The telephone assembly of the integrated appliance 10 includes a handset 38 that is received by a cradle of telephone bezel 20. The handset 38 includes a microphone and speaker. Telephone bezel 20 also mounts a message-waiting light 39 and a telephone subassembly 40. The message-waiting light 39 illuminates, either intermittently or constantly, when an incoming telephone call is received and/or a telephone message has been saved.

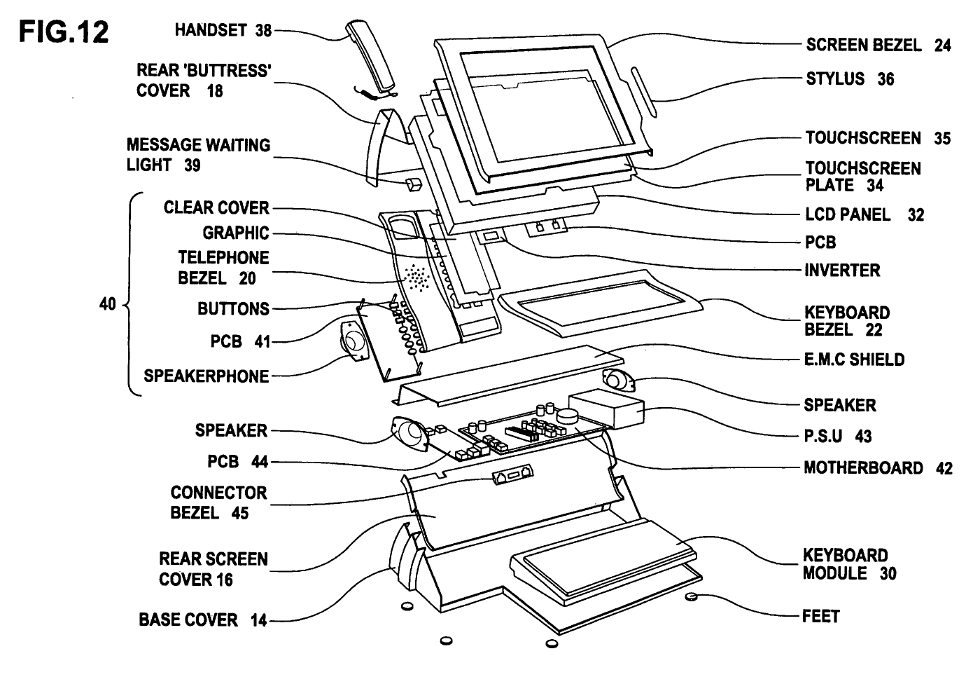

As shown in FIG. 12, telephone subassembly 40 includes a microphone and speaker for hands-free operation, graphics, buttons and a cover. Telephone subassembly 40 also can include actuators for preset one-touch dialing, actuation of one of multiple telephone lines and volume controls, for example.

The telephone assembly also includes a telephone printed circuit board (PCB) 41 for providing various telephony functionality. Telephone PCB 41 is mounted, along with motherboard 42, within the housing 12. A power supply (PSU) 43 also is mounted within the housing and supplies power to the motherboard and various other components after regulating and/or converting power from an external AC power source (not depicted). The PSU preferable is a fanless, open frame, low heat, low wattage PSU.

Motherboard 42 and PCB 44 provide various connectivity associated with the multiple inputs and outputs of the integrated appliance 10. By way of example, the embodiment depicted in FIGS. 10-12 includes a connector bezel 45 that mounts a telephone connector, e.g., an RJ 11 jack, a universal serial bus (USB) connector, and an Ethernet connector, e.g., an RJ 45 jack. As will be described in greater detail later, some embodiments of an integrated appliance can provide communication passthrough functionality.

As used herein, the term “passthrough” refers to communication functionality that is independent of operating system and or software interaction of an integrated appliance. Thus, by providing telephone and Ethernet passthrough, a user can connect a computing device, e.g., a laptop, to a passthrough connector and enable the computing device to communicate with a communication network. Therefore, if the user does not desire to obtain information directly from an integrated appliance, the integrated appliance can accommodate use of the user's computing device.

Various communication connectors are depicted in FIG. 11. In this embodiment, connectors 46 include an S-Video (DIN), line out (3.5 mm jack), two USB connectors, a PS/2 port and an A/C cable. Connectors 47 include a PSTN (RJ12) jack and an external LAN port. A telephone handset jack 48 (RJ22) and a mini PC1 expansion slot 49 also are depicted. Clearly, various combinations and arrangements of connectors other than shown in FIG. 11 can be used in other embodiments.

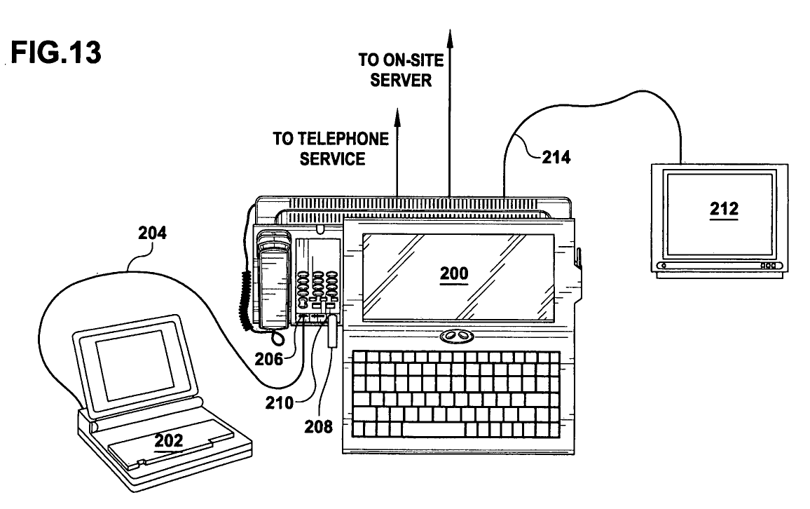

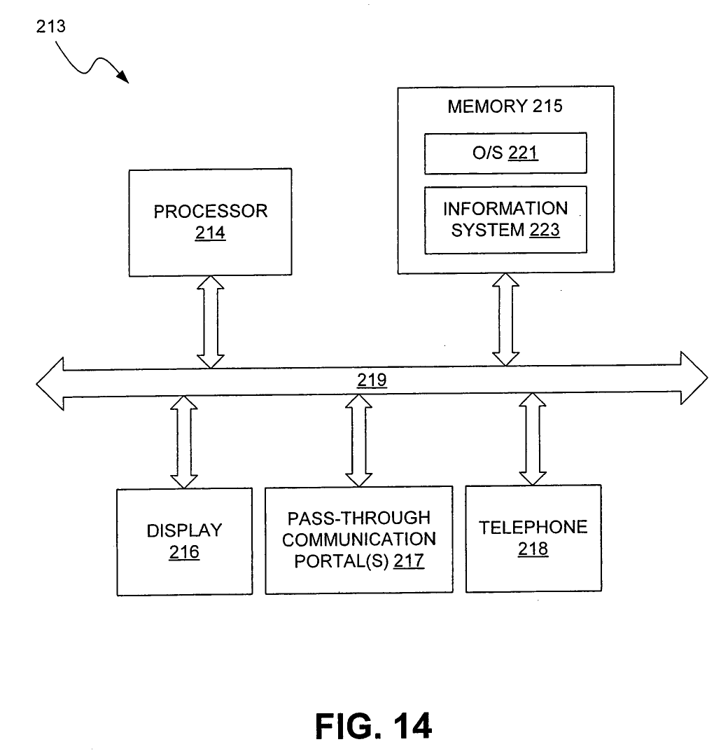

As shown in FIG. 13, an embodiment of an integrated appliance can be used to provide information to a user by interfacing with other devices. For instance, the embodiment of the integrated appliance 200 depicted in FIG. 14 is communicating with a laptop computer 202. Laptop 202 communicates with integrated appliance 200 via cabling 204 that is connected to a passthrough communication port 206 of the integrated appliance. By using the passthrough communication port 206, a user that does not desire to actuate corresponding functionality of the integrated appliance can still send and/or download information using his laptop. However, if the user does not desire to use the laptop, similar functionality can be facilitated by use of the integrated appliance 200, such as by accessing the Internet and/or an e-mail account, as will be described later.

FIG. 13 also depicts use of a security device 208 that is shown inserted in a communication port 210 of the integrated appliance 200. Security device 208 can be a flash memory stick or other device that can contain information for establishing secure communication between the integrated appliance 200 and a network with which the user desires to communicate. Thus, the user could establish a virtual private network (VPN) via use of at least some embodiments of the integrated appliance and an associated security device.

Also shown in FIG. 13 is a television 212. Television 212 receives a television audio/video (A/V) signal via cabling 214, such as an svideo and s/pdif (audio). As described before, at least some embodiments of the integrated appliance incorporate the ability to decode MPEG data. Because of this, integrated appliance 200 can receive data in MPEG form, such as via the on-site server, convert the MPEG data into television A/V signals and provide the A/V signals to the television 212. Thus, the user can view television programming on the television and/or the integrated appliance. In some embodiments, the television and integrated appliance can provide the same or different video and audio. Note, embodiments of an integrated appliance can be used to play audio, such as digital audio files from a digital media library.

Various other features also can be implemented in some embodiments. For instance, some integrated appliances can be designed and/or manufactured in a modular format. Specifically, a mini-PC1 interface on a SODIMM form factor can be provided, as well as a standard 32 bit PCI socket, 2 two-channel IDE interfaces, and possibly additional sockets for manufacturing-time chipset options. Various modules can include a wireless 802.11g module for mini-PC1 expansion, an MPEG decoder/TV encoder card for the PCI socket, an IR receiver, and a separate voice-over-IP module interfacing between the telephone PCB and the telephone jacks.

In those embodiments incorporating an IR receiver, the IR receiver can be used to detect signals provided by a television IR remote control. Such an integrated appliance can attribute the various remote control signals to corresponding functions provided by the integrated appliance so that a user can playback video/audio on the integrated appliance and/or associated television using the remote control. In other embodiments, a separate IR controller can be provided.

With respect to embodiments that incorporate voice-over-IP (VOIP), the telephone handset and telephone electronics can be used to place and receive telephone calls that are intercepted by a VOIP module and transformed into digital VOIP packets sent over the network to an associated on-site server. The on-site server sends the VOIP packets to a VOIP gateway, either on the Internet, or located at the facility.

With respect to casualty modes of operation, some embodiments of an integrated appliance are able to provide limited functionality even when power outages occur. For instance, the ability to dial 911 can be provided during a power outage, i.e., some embodiments function like an analog telephone in that respect. In those embodiments that incorporate VOIP functionality, a power outage can cause the integrated appliance to default to analog telephone service as well. Also, in those embodiments that incorporate power-over-Ethernet service, Ethernet service also can be provided under a power outage condition if the equipment facilitating such service, e.g., the on-site server has a functioning power back-up.

Security implementations also are provided in some embodiments. For instance, some embodiments support the 802.1q protocol providing for a separate VLAN tag for a computing device, such as a laptop. This 802.1q support integrates with upstream network equipment providing seamless security between a 3rd party network or HSIA solution, and the computing device. Additionally or alternatively, an integrated appliance can provide information filtering functionality that can be adapted to render inappropriate textual language, competing facility content and improper ad sizing from being displayed by an integrated appliance.

An example of another embodiment of an integrated appliance is shown schematically in FIG. 14. Integrated appliance 213 of FIG. 14 includes a processor 214, memory 215, and one or more input and/or output (I/O) devices, such as display 216, passthrough communication portal(s) 217, telephone 218 and possibly other I/O devices, e.g., network connectors, that are communicatively coupled via a local interface(s) 219. The memory 215 can include one or more separate programs, each of which comprises an ordered listing of executable instructions for implementing logical functions. In the example of FIG. 14, the memory 215 includes an operating system (O/S) 221 and an embodiment of an information system 223.

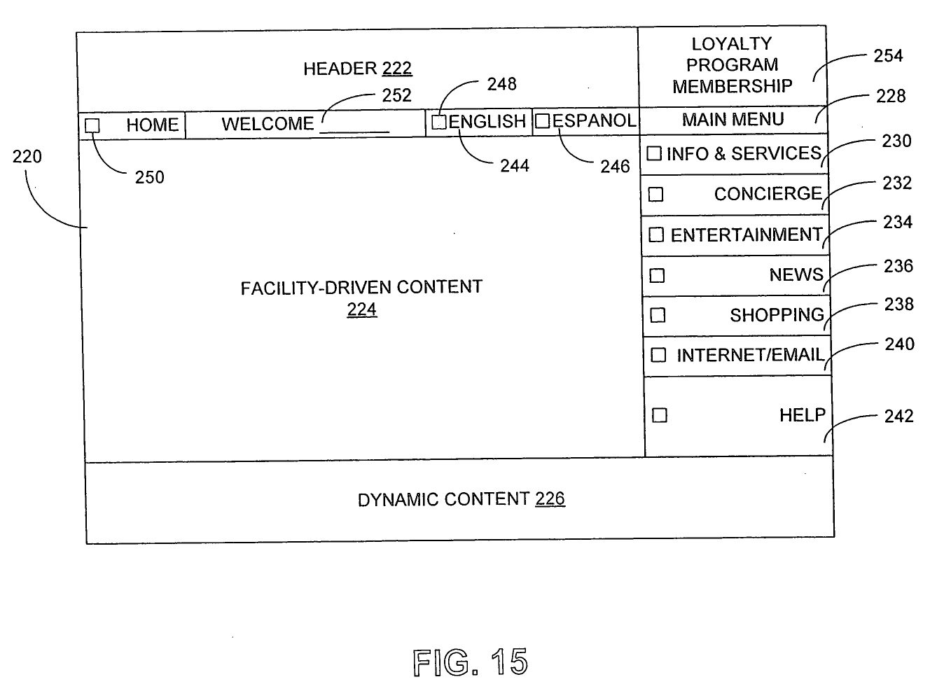

The information system of an integrated appliance, such as information system 223 of FIG. 14, can be used to provide various functionality. By way of example, such an information system can be used to provide a user with a graphical user interface (GUI) that includes multiple screens of information. Although multiple representative screen shots will be described in detail later with respect to FIGS. 15-19, general functionality associated with a representative embodiment of an information system will be described here.

By way of example, the embodiment of the information system 223 of FIG. 14 can provide a facility with a display that can be varied based upon the desired look, colors and graphics that the facility desires. Preferably, facility-specific information can be updated locally, e.g., by facility staff. Other content provided by the integrated appliance can be dynamic in nature, in that at least a portion of the content can be provided based upon information corresponding to the particular user or guest. For instance, when the facility is a lodging facility, information corresponding to the name and/or address of the guest can be used to provide personally customized greetings to the guest via the display of the integrated appliance. Further, news associated with the guest's address, e.g., the guest's hometown, also can be provided via the integrated appliance.

Reference will now be made to FIGS. 15-19, which are representative screen shots that can be displayed by an embodiment of an integrated appliance for facilitating at least some of the functionality described above. As shown in FIG. 15, which depicts a screen shot provided by a graphical user interface (GUI) via a display assembly of an integrated appliance, the user is provided with information in various forms. Specifically, screen shot 220 includes a header 222 that can be standardized across the various screen shots provided by the GUI. By way of example, when the screen 220 is associated with a lodging facility, the name of the lodging facility could be displayed in the header 222. Screen 220 also includes fields for facility-driven content and dynamic content, which are depicted as fields 224 and 226, respectively. As mentioned before, the facility-driven content can be provided and/or modified by the facility so that information that may change on a daily basis, for example, can be managed on-site. In contrast, the dynamic content provided in field 226 can be provided by a host server and/or on-site server associated with the integrated appliance, and can be used to provide geographic and/or demographically driven information to a particular user.

Screen 220 also includes a menu 230 which, in this embodiment, includes an actuator or link for accessing information & services 230, concierge 232, games & entertainment 234, news 236, shopping 238, Internet/e-mail 240 and help 242. Note, several of the aforementioned menu items will be described in detail later.

Screen 220 also includes functionality for changing the language of the display. In particular, screen 220 includes an English actuator 244 and a Spanish actuator 246. Note that the English actuator 244 is actuated, with an indicator 248 being illuminated to indicate that the English language has been selected. An indicator 250 also is provided to show that screen 220 is indicative of the home page of the GUI. A “welcome” field 252 also is provided within which the name of a user can be displayed. This enables the screen to be customized based upon the anticipated user.

A loyalty program membership actuator 254 also is provided that can be actuated by a user to enroll and/or utilize aspects of a loyalty program that is facilitated by the integrated appliance. In this regard, depending on various business relationships established with loyalty programs, the integrated appliance can be used to receive user inputs for converting loyalty reward points, and the like, for use in upgrading amenities, for example, that can be provided through the integrated appliance.

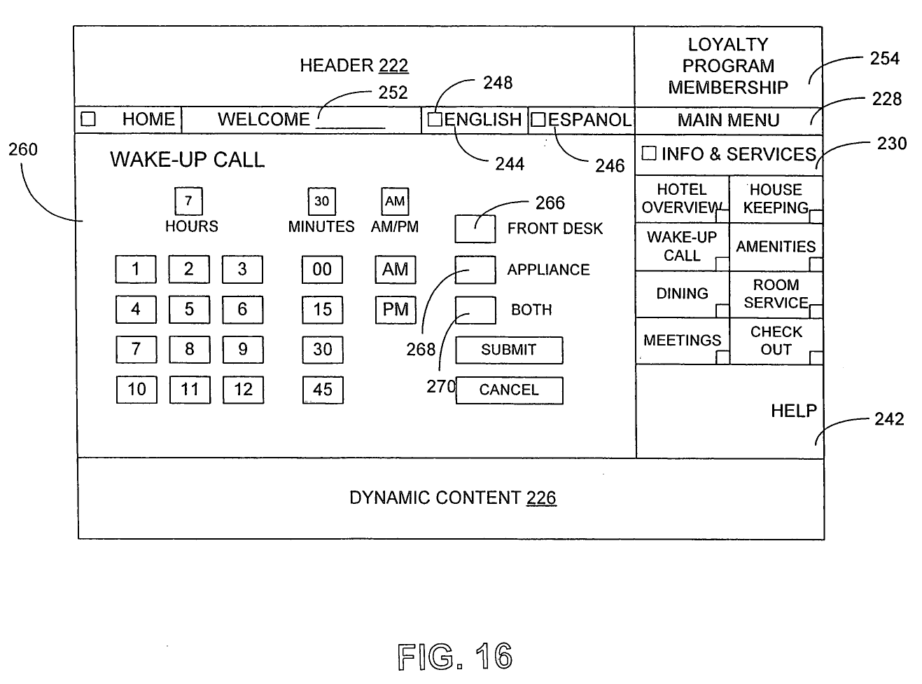

Referring now to FIG. 16, a screen 260 is depicted that can be provided in response to a user actuating the information & services actuator 230 of FIG. 15. As shown in FIG. 16, screen 260 includes various actuators for establishing a wake-up call for the user. In this regard, a virtual keypad is depicted that can be used for entering the time that a wake-up call is desired. Also note that various options are provided in the form of actuators 236, 237 and 238 for enabling the user to select the manner in which the wake-up call is to be accomplished. In this embodiment, actuator 266 corresponds to the user desiring a telephone call for wake-up, actuator 268 corresponds to the integrated appliance waking the user with audio provided by the onboard speaker and/or video on the display, and actuator 270 corresponds to both of the aforementioned forms of wake-up. An actuator 272 then can be used to submit information corresponding to the desired wake-up call to the on-site server so that the aforementioned functionality can be accomplished. Note that, in some embodiments, information is communicated to the Property Management System or facility telephone system (PBX), for example, so that a wake-up call can occur.

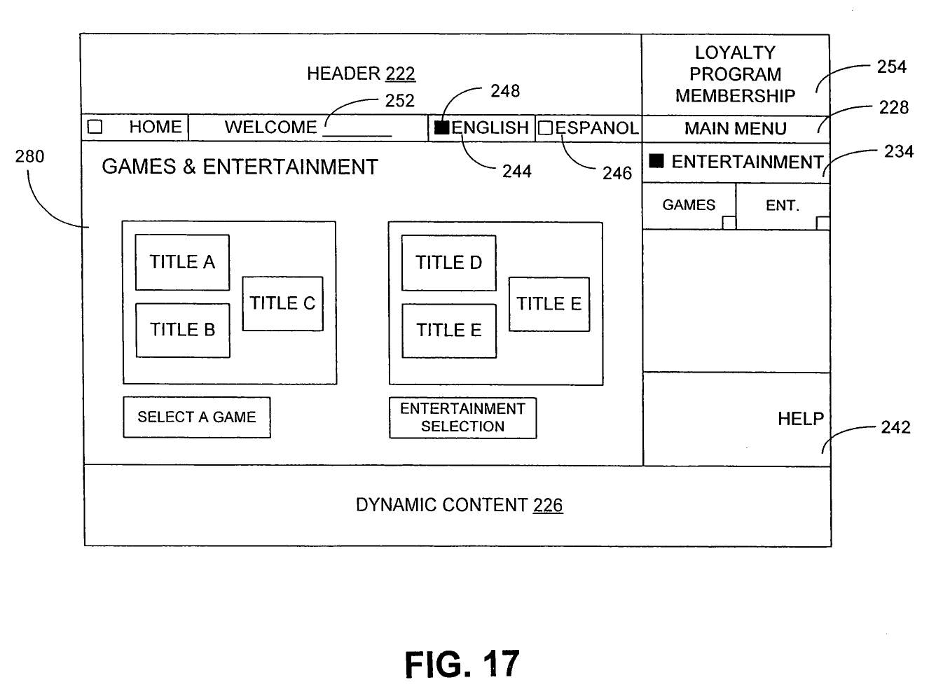

FIG. 17 depicts a screen 280 that can be provided to a user when actuator 234 is actuated. As shown in FIG. 17, the user is provided with a selection of games and/or entertainment, such as movies, that can be provided by an integrated appliance. Note that, in some embodiments, when either a game or movie is selected, a charge can be posted to the user's facility account, thereby generating revenue for the facility. As mentioned before, gaming functionality can involve the use of a game controller, for example, that can be interconnected to an integrated appliance through one or more of the various communication connectors. Similarly, movies can be displayed to the user via a television that receive television signals from the integrated appliance. Note that in addition to, or in lieu of, displaying gaming or movies with the display assembly of an integrated appliance, the games and movies can be displayed with a television that is communicating with the integrated appliance.

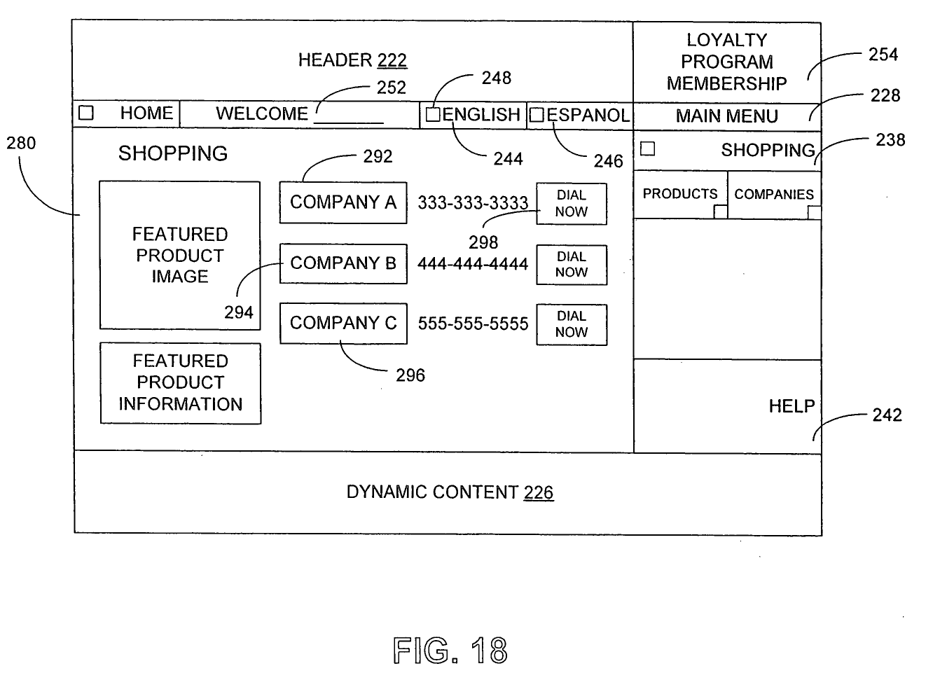

FIG. 18 depicts a screen 290 that can be displayed to a user in response to actuating shopping actuator 238. Screen 290 includes various actuators or links, such as actuators 292, 294, 296, each of which corresponds to a particular product, line of products, or company, for example. Also associated with each of the product actuators is a “dial now” actuator. For instance, dial now actuator 298 corresponds to the company actuator 292. Thus, when the user actuates dial now actuator 298, a telephone connection automatically is established between the telephone of the integrated appliance and the establishment associated with the company actuator. Therefore, the user does not have to dial the telephone number and may be more likely to follow through with an impulse purchase. Information corresponding to such a purchase also could be acquired by the on-site server and potentially communicated to an associate host server so that dynamic content corresponding to such a purchase can be provided to the user.

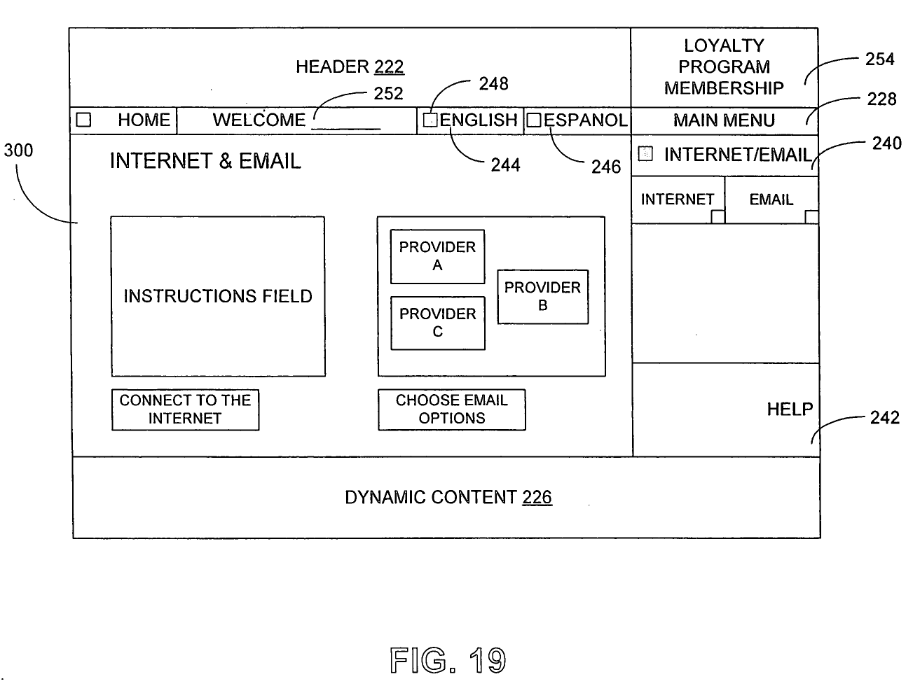

FIG. 19 depicts a screen 300 that can be displayed to a user in response to actuating the Internet/e-mail actuator 240. Screen 300 includes actuators 302 and 304 for enabling a user to connect with the Internet and to check e-mail, respectively. As mentioned before, if a user does not desire to use the Internet and/or e-mail functionality provided by an integrated appliance, the user can use the passthrough data connectivity provided by an integrated appliance.

It should be emphasized that many variations and modifications may be made to the above-described embodiments. All such modifications and variations are intended to be included herein within the scope of this disclosure and protected by the following claims.

1. A method for generating multiple revenue streams, said method comprising the steps of:
providing an integrated appliance for use in a room of a lodging facility, the integrated appliance being operative to provide Internet access and telephone service to the room;
generating a first revenue stream corresponding to the providing of the integrated appliance;
acquiring information corresponding to a guest of the lodging facility;
displaying content, in-room, to the guest of the lodging facility using the integrated appliance, the content being based, at least in part, on the information corresponding to the guest; and
generating a second revenue stream corresponding to displaying the content using the integrated appliance.

2. The method of claim 1, wherein the step of displaying content comprises the step of displaying of a digital video advertisement.

3. The method of claim 1, wherein the step of generating the second revenue stream comprises generating the second revenue stream in response to the guest purchasing at least one of a product and a service associated with the content.

4. The method of claim 1, wherein, in acquiring the information corresponding to the guest, a Property Management System database of the lodging facility is accessed for the information.

5. The method of claim 1, wherein:
the step of acquiring information comprises the step of acquiring demographic information corresponding to the guest; and
the method additionally comprises selecting the content based on the demographic information.

6. The method of claim 1, further comprising:
providing the guest with Internet access using the integrated appliance; and
generating a third revenue stream corresponding to the providing of the Internet access.

7. The method of claim 6, further comprising:
providing the guest with telephone service using the integrated appliance; and
generating a fourth revenue stream corresponding to the providing of the telephone service.

8. The method of claim 1, further comprising:
providing information corresponding to use by the guest of the integrated appliance.

9. The method of claim 8, further comprising:
generating a third revenue stream corresponding to the providing of the information.

10. The method of claim 8, wherein the information corresponding to use by the guest of the integrated appliance is provided to the lodging facility.

11. The method of claim 1, further comprising:
using the integrated appliance to display movies to the guest; and
generating a third revenue stream corresponding to the display of the movies.

12. The method of claim 11, wherein, in using the integrated appliance, the integrated appliance receives MPEG data and converts the MPEG data to television audio/video for display by a television.

13. The method of claim 1, further comprising:
using the integrated appliance to convert loyalty reward program incentives owned by the guest into at least one of a product and a service.

14. The method of claim 13, wherein the at least one of a product and a service is associated with the lodging facility.

15. The method of claim 1, further comprising:
generating a third revenue stream corresponding to the using of the integrated appliance to convert the loyalty reward program incentives.

16. A system for generating multiple revenue streams comprising:
an integrated appliance having a display and being operative to:
display content to a user via the display; and
provide the user with passthrough communication connectivity such that the user can interconnect a computing device to the integrated appliance and be provided with at least one of passthrough telephone network access and passthrough Internet access.

17. The system of claim 16, further comprising:
an on-site server communicating with the integrated appliance and operative to:
receive content to be displayed by the integrated appliance; and
communicate the content to the integrated appliance such that the content is displayed to the user via the integrated appliance.

18. The system of claim 17, further comprising:
a host server communicating with the integrated appliance and operative to:
receive content to be displayed by the integrated appliance;
receive information corresponding to the user;
correlate the information corresponding to the user with the content; and
communicate the content to the integrated appliance associated with the user, with the content being based, at least in part, upon the information corresponding to the user.

19. The system of claim 18, wherein:
the on-site server receives at least some of the content provided to the integrated appliance from a source other than the host server.
